(19) United States
(12) Patent Application Publication
(10) Pub. No.: US 2018/0093330 A1
(43) Pub. Date: Apr. 5, 2018

(54) CUTTING TOOL AND METHOD FOR ITS MANUFACTURE

(71) Applicant: Kennametal Inc., Latrobe, PA (US)

(72) Inventors: Tim Guter, Zirndorf (DE); Herbert Rudolf Kauper, Erlangen (DE)

(73) Assignee: Kennametal Inc., Latrobe, PA (US)

(21) Appl. No.: 15/362,384

(22) Filed: Nov. 28, 2016

(30) Foreign Application Priority Data
Nov. 26, 2015 (DE) 1020152234844

(51) Int. Cl. B23B 27/00; B23B 51/02; B23C 5/28; B24B 3/26

(52) U.S. Cl. CPC B23B 27/005; B23B 51/02; B23C 5/28; B23B 2251/14; B23B 2251/12; B23C 2200/32; B23B 2260/072; B24B 3/26

(57) ABSTRACT

A cutting tool (2)—in particular a rotary tool—is described, having a cutting edge (4) from which a rake face (6) and a clearance face (8) extend, characterized in that a groove (12) is introduced into the clearance face (8) in a region along the cutting edge (4) so that a part of the clearance face (8) is formed as a wear face (14) that extends between the groove (12) and the cutting edge (4) and is bounded by the groove (12) and the cutting edge (4). The groove (12) advantageously limits the wear of the cutting tool (2) in the region of the cutting edge (4) on the wear surface (14), so that overall the frictional forces that occur are kept small and the service life of the cutting tool (2) is extended. Furthermore, a cutting element for a cutting tool (2) as well as a method for manufacturing the cutting tool (2) are described.

### RELATED APPLICATIONS

This application claims priority to German Patent Application No. 1020152234844 filed Nov. 26, 2015. The contents of the foregoing application are incorporated herein by reference in their entirety.

### FIELD OF THE INVENTION

The invention relates to a cutting tool, in particular a rotary tool having a cutting edge, to which a rake face and a clearance face connect. The invention further relates to a method for manufacturing the cutting tool.

### BACKGROUND

Corresponding cutting tools formed as drills are described in, for example, DE 10 2013 205 889 B3, DE 10 2014 207 501 A1 and the unpublished DE 10 2015 210 817, which traces back to the applicant.

A cutting tool generally serves for machining a workpiece from which material is removed by raking action. To do this, the clearance face and the rake face form a wedge at the tip of which is situated the cutting edge that attacks the material. On the side of the rake face, a chip is produced and transported away via the rake face. In contrast, the clearance face points toward the workpiece and with it encloses an angle, which is known as the clearance angle.

During the machining of a workpiece, the cutting edge abrades and the cutting tool is worn down in the area of the cutting edge, and in fact in particular on the clearance face which faces the workpiece. Typically, the clearance face here is flattened close to the cutting edge, with the consequence being intensified friction between the cutting tool and the workpiece. The greater the wear, the higher the friction and the higher the mechanical loading of the tool.

The task is achieved according to the invention by a cutting tool having a cutting edge, a rake face connected to the cutting edge, and a clearance face connected to the cutting edge, wherein the clearance face has a groove disposed in a region along the cutting edge so that the clearance face is formed as a wear surface that extends between the groove and the cutting edge and is bounded by the groove and the cutting edge. The task is also achieved by a cutting element having a cutting edge, a rake face connected to the cutting edge, and a clearance face connected to the cutting edge, wherein the clearance face has a groove disposed in a region along the cutting edge so that the clearance face is formed as a wear surface that extends between the groove and the cutting edge and is bounded by the groove and the cutting edge. The task is also achieved and by a method for manufacturing a rotary cutting tool having a cutting edge, a rake face connected to the cutting edge, and a clearance face connected to the cutting edge, the method comprising forming a groove in the clearance face of the cutting tool at a distance from the cutting edge of the cutting tool so that part of the clearance face is formed as a wear face that extends between the groove and the cutting edge, the wear face being bounded by the groove and the cutting edge. Advantageous embodiments, refinements and variants are also described herein. Thus, the embodiments in connection with the cutting tool also apply accordingly to the cutting element and to the method, and vice versa.

The cutting tool is, in particular, designed as a rotary tool, i.e. in particular, as a drill, milling cutter, reamer or the like. In general, a rotary tool has a rotational axis about which the rotary tool rotates while in operation. The cutting tool has a cutting edge for machining a workpiece. A rake face and a clearance face, which together enclose a cutting angle, extend from the cutting edge. During operation, the rake face is used to remove chips that have been produced, and the clearance face faces the workpiece and together with it encloses a clearance angle. A groove is introduced into the clearance face in an area along the cutting edge, so that a part of the clearance face facing the cutting edge is formed as a wear surface that extends between the groove and the cutting edge and is bounded by the groove and the cutting edge.

During machining, the cutting tool is regularly worn in the area of the cutting edge, and the clearance face is deformed accordingly. As a result, the clearance face in the area of the cutting edge is typically flattened, meaning that a worn surface or wear surface is formed as a part of the clearance face. As a result, the contact surface between the cutting tool and the workpiece increases, such that the friction on the workpiece in the region of the cutting edge increases. This effect typically becomes more intense as wear progresses, because a correspondingly greater worn surface is produced by a progressive flattening.

The invention is now based on the idea of limiting the progressive expansion of the worn surface by incorporating a groove into the clearance face behind the cutting edge (in the cutting direction). This groove essentially extends along the cutting edge and represents a recess in the clearance face so that, if there is wear in the clearance face between groove and cutting edge, the worn surface reaches the groove as of a specific degree of wear and then initially cannot grow further, i.e. become wider. As a result, the increase in the friction due to progressive wear is effectively limited, and the service life of the cutting tool is substantially improved. Thus, wear is initially limited to the wear surface that extends starting from the cutting edge, and in particular behind it up to the groove. Overall, the wear of the cutting edge—and the flattening of the clearance face that is typically associated with it—is limited to the wear surface; the remaining clearance face on the other side of the groove at first remains unscathed. A growth of the actual worn surface beyond the wear surface and the groove is advantageously avoided.

The wear limitation concept described above is basically suitable for any cutting tools, meaning both rotary tools as well as other cutting tools that, in operation, do not rotate about their own axis of rotation. Moreover, this concept is suitable both for one-piece cutting tools (such as simple drills, milling cutters or reamers) as well as modular cutting tools, meaning tools with a carrier and an exchangeable cutting element or cutting insert that is attached to the carrier via a suitable coupling. Such a modular cutting tool is in particular a drill having an exchangeable drill head as described in DE 10 2013 205 889 B3, which was cited at the outset, said carrier then having a number of (in particular helical) chip flutes that are continued in the drill head and each forming a rake face there. Such an exchangeable drill head, generally a cutting head, therefore forms a cutting element in the sense of the present invention. Preferably, this cutting head has a coupling pin with which it can, in particular, be inserted to clamp within a pin receptacle of a carrier. Preferably, the clamping attachment takes place by turning the cutting head approximately 90° relative to the carrier in order to form a—preferably clamping—connection, in particular without additional fastening means such as screws.

Furthermore, a use in modular tools with what are known as cutting plates as a cutting element is also conceivable. Also, in this case, a respective cutting element has a cutting edge from which respectively extend a rake face and a clearance face that typically face the workpiece. Moreover, an application to cutting tools that are not rotary tools—such as cutting plates and chisels for lathes and the like—is also conceivable. In particular, only the presence of a cutting edge on the cutting tool is generally essential for advantageous application of the presented concept.

### BRIEF DESCRIPTION OF THE DRAWINGS

FIG. 1 illustrates a cutting edge of a conventional cutting tool in a side view, to clarify wear during operation.

FIG. 2 illustrates a side view of a cutting edge of a cutting tool according to the invention, to clarify wear during operation.

FIG. 3 illustrates a front view of drill according to the invention.

FIG. 4 illustrates a side view of the drill of FIG. 3.

### DETAILED DESCRIPTION

Embodiments described herein can be understood more readily by reference to the following detailed description and examples and their previous and following descriptions. Elements and apparatus described herein, however, are not limited to the specific embodiments presented in the detailed description. It should be recognized that these embodiments are merely illustrative of the principles of the present invention. Numerous modifications and adaptations will be readily apparent to those of skill in the art without departing from the spirit and scope of the invention.

The invention can therefore logically be transferred—and with the corresponding advantages—to a cutting element for a cutting tool, the cutting element then having a cutting edge from which a rake face and a clearance face extend, and a groove being introduced into the clearance face in a region along the cutting edge, so that a part of the clearance face is formed as a wear surface that extends between the groove and the cutting edge and is bounded by the groove and the cutting edge. The cutting element in that instance is, for example, a drill head or a cutting plate.

The term cutting edge very generally means a typically sharp edge, in particular one formed by grinding, that during operation cuts into the workpiece for the purpose of removing chips. A drill typically has multiple cutting edges, each of which is characterized as a main cutting edge and which in particular are joined to each other via, for example, an S-shaped chisel edge, and in this way form, in particular, a compound cutting edge. The end face, together with the main cutting edges, forms a forward end of a cutting part that is provided with chip flutes, which are usually helical. Secondary cutting edges, which meet the main cutting edges at a cutting corner, typically run along the chip flutes. A ridge, in particular a body clearance of the cutting part, extends around the perimeter between two chip flutes. Preferably, main cutting edges of the cutting tool are presently understood as falling under the term cutting edges.

Preferably, the cutting tool is a drill in which the grooves are introduced into the clearance faces at the end face that are associated with the main cutting edges.

In order to benefit, on the one hand, from the advantages achieved by the groove and, on the other hand, to not disadvantageously affect the stability of the cutting tool, the groove and the wear surface are expediently suitably dimensioned, meaning that they have suitable dimensions.

Therefore, the wear surface, measured from the groove to the cutting edge, has a width that is preferably between 0.1 and 0.3 mm. This achieves a sufficient service life until the cutting tool is changed or until resharpening of the cutting edge, and at the same time friction in operation is limited to a sufficient degree.

Furthermore, the groove has a groove depth that, in one preferred embodiment, is between 0.05 and 0.1 mm. This is based on the consideration that, on the one hand, a certain groove depth must be formed in order to realize a limiting of the wear over a longer time frame and achieve a suitable service life extension. On the other hand, however, the groove also should not be so deep that the stability of the cutting tool in the area of the cutting edge is significantly impaired and the cutting edge does not break off. The forces occurring during the cutting are efficiently transferred to the entire cutting tool because of the preferred flat configuration of the groove. The groove depth is preferably constant along the entire groove; however, a varying groove depth is also conceivable in principle.

The groove additionally has a groove depth that is, in particular, measured in the direction of the width of the wear surface. The groove width is preferably between 0.05 and 0.1 mm, meaning that the groove is, in particular, narrower than the wear surface. This design ensures that the cutting tool in the region of the cutting edge during operation is still sufficiently stable during operation, and that the forces occurring during the cutting continue to be efficiently transferred to the entire cutting tool. In particular, the groove is approximately as deep as it is wide.

The groove runs generally in one groove direction and, in cross-section, preferably has a curved contour transversal to the direction of the groove. As a result, a sufficient stability of the cutting tool is, in particular, ensured because a formation of torsional maximums is prevented by the generally rounded contour. Instead, any forces are distributed particularly uniformly by the special embodiment of the contour. The groove forms, in particular, a cavity in the clearance face and is appropriately designed as edge-free as possible, at least apart from the transitions from the groove to the clearance face. The contour of the groove is accordingly configured as a circular segment, for example.

Starting from a starting point and up to an endpoint, the groove basically runs essentially along the cutting edge. Moreover, the groove preferably runs without interruption, i.e. consistently or continuously, so that the wear limit over the entire course of the groove is realized between starting point and end point.

In a first suitable variant, the groove runs parallel to and at a constant distance from the cutting edge. As a result, the wear surface is formed along the cutting edge having a constant width, in other words with uniform wear limitation in the region of the cutting edge.

In a second suitable variant, the groove by contrast runs from an inner starting point to an outer end point and, with respect to the cutting edge, is at a distance that increases toward the end point. In other words: the wear surface is widened or even spread out along the cutting edge. In the case of a curved cutting edge, for example, this is achieved by the groove being of straight design. The wear surface spreading out toward the end point primarily results in a substantially increased stability at the wider end, especially at or in the vicinity of a cutting corner. As a result, the cutting tool has sufficient stability even in the highly stressed region of the cutting corner. In this sense, with a rotary tool the inner starting point is accordingly closer to the rotational axis than is the end point, so that the groove extends somewhat radially outward starting from the starting point.

In one preferred embodiment, the cutting tool has a base body having a number of chip flutes that are introduced into the base body and having a core that is formed between the chip flutes and has a core diameter, the groove running only outside of the core diameter, in particular beginning at the core diameter. Thus, the groove is not formed in the core region. In the case of a rotary tool, the starting point of the groove in that case is offset by at least half the core diameter from the rotational axis and extends outward from this point. In this context, the core is essentially defined by the chip flutes, which penetrate into a base body as recesses down to the core.

In particular, in the preferred embodiment as a rotary tool, the cutting tool has a nominal radius, and the groove has a groove length that—in one preferred variant—is at least 30% of the nominal radius. In other words: the cutting edge has a cutting edge length, and the groove is formed over only a limited section along the cutting edge, the groove having a groove length that is preferably at least about 30% of the cutting edge length. It is thereby ensured, in particular, that the groove extends over a significant range and thereby results in a sufficient limiting of the wear. The nominal radius of the cutting tool is measured in particular from the center of the same out to an outer peripheral edge, in particular to a cutting corner.

The cutting tool has, in particular, a peripheral outer edge, meaning an outer edge that, in particular, delimits the clearance face. In a first suitable refinement, the groove now is now formed consistently out to the outer edge. The groove therefore opens out at the outer edge and without any limitation. Thus, the wear surface is still formed even in the outermost region of the cutting edge and limits excessive wear precisely where especially intense forces are at work during operation. The outer edge is, in particular, an edge that is formed by the clearance face and an outer wall that abuts it; in the case of a drill, this is what is known as the body clearance.

In a second appropriate refinement, the groove by contrast extends only up to an end point that is situated inside the clearance face and is at a distance from the outer edge, meaning that the groove is not quite consistently executed up to the outer edge; rather, an ungrooved region of the clearance face remains. In the case of a drill, this ungrooved region is then in the vicinity of the typically heavily loaded cutting corner. The non-continuous design of the groove thereby generally ensures an improved stability in the—typically especially heavily stressed and outermost—region of the cutting edge. In particular, the end point is set at a maximum distance of 10% of the nominal radius of the cutting tool, preferably a maximum of 5%, from the outer edge. Generally, the end point is spaced from the outer edge, in particular by a clearance that is substantially less than the cutting length and corresponds to, for example, a maximum of roughly 10% of the cutting edge length.

Expediently, at least the clearance face is provided with a coating in order to form the cutting tool in particular to be wear-resistant. For example, the coating is made from an especially hard material in order to improve the service life of the cutting tool in general. The coating is thus applied either before or after the formation of the groove so that the coating is then correspondingly either interrupted by the groove or is also formed in the groove. Preferably, it is not the clearance face that is exclusively provided with the coating but, for example, the entire cutting tool or—in the case of a modular tool—the entire drill head or the entire cutting plate.

For the manufacture of the cutting tool, a groove is introduced into a clearance face of the cutting tool along and at a distance from the cutting edge of the cutting tool. In one preferred embodiment, the groove is formed via a laser, which, in particular, makes it possible to produce a groove having the aforementioned dimensions in a simple manner. Moreover, by machining using a laser, in contrast to mechanical machining using, for example, a grinding wheel or a milling cutter, no force is exerted on the cutting tool, thereby avoiding an inadvertent breakage of the cutting edge during manufacture. Moreover, the fine structures of the groove can only be introduced with difficulty when a grinding wheel is used. Therefore, any contact-free cutting or ablation method—for example even plasma beam cutting or electron beam cutting—is generally suitable. Moreover, even cutting tools made from an especially hard, hardened or coated material made (for example from carbide) can be machined easily using a laser and generally using a contact-free cutting or ablation method.

In one preferred embodiment, the cutting tool or at least the cutting element is made of carbide. Moreover, any previous cutting tools can be particularly advantageously retrofitted very easily by subsequently introducing a corresponding groove into them.

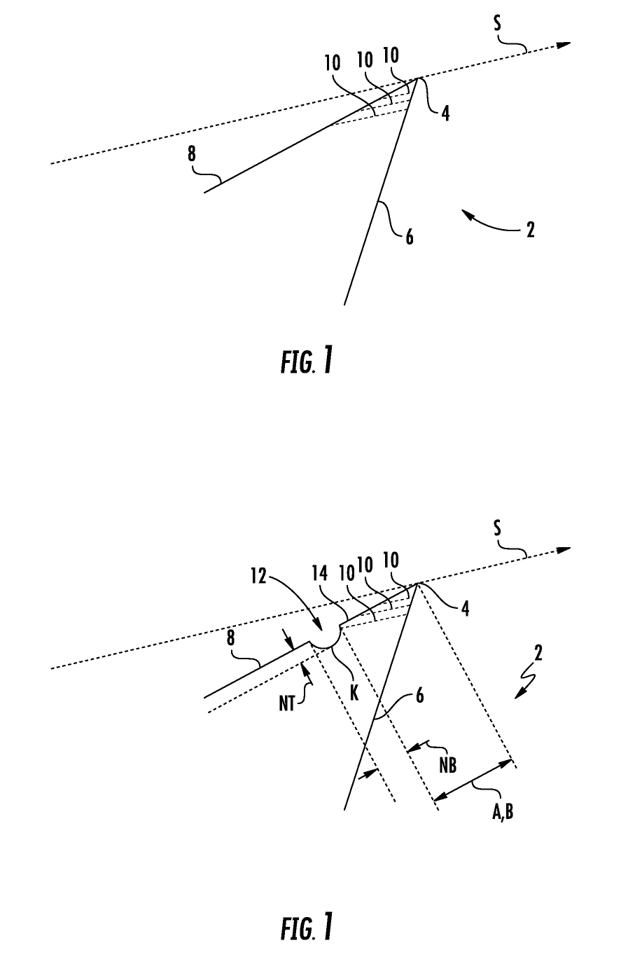

To highlight the wear of a cutting tool 2 during operation, a cutting edge 4 of cutting tool 2 is depicted in a lateral cross-section in FIGS. 1 and 2. A conventional cutting edge 4 is shown in FIG. 1; a cutting edge 4 according to the invention is shown in FIG. 2. A rake face 6 and a clearance face 8 extend starting from the cutting edge 4. Chips, which are transported away via cutting edge 4 during operation, are removed via the rake face 6. The clearance face 8 typically faces a workpiece (not shown in detail here) during operation.

Basically, the cutting edge 4 is moved in a cutting direction S during operation, it thereby attacks the workpiece, which wears down accordingly during operation. The wear is indicated in FIGS. 1 and 2 by dashed lines in the region of the cutting edge 4. It becomes clear in this context that, due to wear, a part of the clearance face 8 forms a worn surface 10 that becomes increasingly wider with progressive wear. During operation, frictional forces then act in the region of the cutting edge 4, which also becomes larger with progressive wear because of the further enlarged worn surface 10. In the case of the cutting tool according to the invention as in FIG. 2, this expansion is prevented by a groove 12, because of which the worn surface 10 does not continue to grow past a certain wear but rather remains essentially the same width so that the frictional forces during operation do not also increase further. As a result, the service life of the cutting tool 2 is significantly extended.

For this purpose, the groove 12 is introduced into the clearance face 8 and runs in a groove direction N and essentially along the cutting edge 4. In a cross-section transversal to the groove direction N, as shown in FIG. 2, the groove 12 has a contour K which in this case is curved and, in particular, is formed in the shape of a circular arc; in other words, the contour K is free of edges. As a result, stress peaks during operation are prevented and the active forces are distributed overall in an especially homogeneous manner.

In order to further ensure a good stability of the cutting tool 2 in the area of the cutting edge 4, and to avoid an undesired breakage of the cutting edge 4, the groove 12 has a comparatively flat design and has a groove depth NT which, in this instance, is between 0.05 and 0.1 mm. Furthermore, the groove 12 has a groove width NB that roughly corresponds in particular to the groove depth NT, and in this instance, is within a range of 0.05 to 0.1 mm. Furthermore, the groove 12 is at a distance A from the cutting edge 4, which distance A in this instance is roughly 0.1 to 0.3 mm. The distance A likewise corresponds in this context to a width B of a wear surface 14 which is formed by the groove 12 between it and the cutting edge 4. The wear surface 14 is a part of the clearance face 8 and is then worn during operation, whereas the remaining part of clearance face 8 (which is behind the groove 12 with respect to the cutting edge 4), initially remains unscathed.

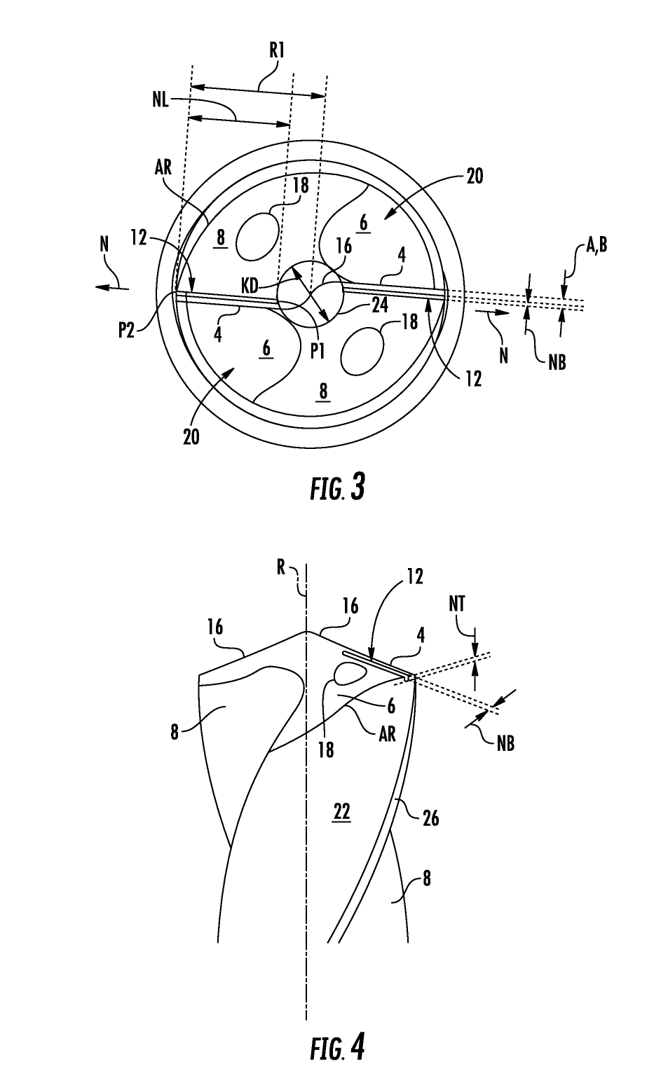

In FIGS. 3 and 4, a cutting tool 2 that is formed as a drill, i.e. as a rotary tool which rotates about a rotational axis R during operation, is shown in various views. Cutting tool 2 has two cutting edges 4 on the front side, i.e. on the end face, that in this instance are main cutting edges of the cutting tool 2 that are connected via an S-shaped chisel edge 16 in the center Z. Measured from the center Z to the outer edge AR, the cutting tool has a nominal radius R1. A clearance face 8 and a rake face 6 extend from a respective one of the cutting edges 4. The cutting tool 2 shown here also has a number of coolant outlets 18 arranged in clearance faces 8 at the end face. The rake faces 6 are each part of a chip flute 20, which in this case has a helical configuration. On the periphery, a body clearance 22 is formed in each case between two chip flutes 20. The chip flutes 20 further define a core 24 of the cutting tool 2 into which the chip flutes 20 do not project, and which thus is of solid design and has a core diameter KD.

The cutting tool 2 which is shown in FIGS. 3 to 4 has two grooves 12 on the end face, each of which extends essentially parallel to one of cutting edges 4 and—with respect to the cutting direction S—is arranged behind one of the cutting edges 4, namely in one of clearance faces 8. A respective groove 12 begins at an inner starting point P1 and extends up to an outer end point P2. The starting point P1 is at least half the core diameter KD away from the axis of rotation R. In the case of the cutting tool 2 shown here, the starting point P1 is on the core diameter KD, but in another variant (not shown) it is further to the outside, in other words further away from the axis of rotation R. The end point P2 in the depicted cutting tool 2 is in the region of a land 26, and generally on an outer edge AR that is formed by clearance face 8 and body clearance 22. In other words, the groove 12 has a consistent design out to the outer edge AR. In another variant (not shown), the groove 12 is by contrast not formed up to the outer edge AR, but instead the end point P2 is within the clearance face 8 and is then set at a distance from the outer edge AR, and said distance, in fact, being at most approximately 10% of the nominal radius R1 of cutting tool 2. In general, the groove 12 additionally has a groove length NL that is at least 30% of the nominal radius R1.

In FIGS. 3 to 4, a respective groove 12 is formed straight and parallel to a respective one of the cutting edges 4. In another variant (not shown), the groove 12 by contrast runs in a curve, for example, and thereby follows parallel to a generally curved cutting edge 4, for example. Alternatively, the groove 12 does not run at all parallel to the cutting edge 4, but instead runs in such a way that the distance A from the cutting edge 4 to the end point P2 is extended, meaning that the wear surface 14 has an increased width B toward the outside, thus toward the outer edge AR.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A rotary cutting tool comprising:
a cutting edge, a rake face connected to the cutting edge, and a clearance face connected to the cutting edge,
wherein the clearance face has a groove disposed in a region along the cutting edge so that the clearance face is formed as a wear surface that extends between the groove and the cutting edge and is bounded by the groove and the cutting edge.

2. The cutting tool of claim 1, wherein:
the rotary cutting tool is a drill; and
the cutting edge is a main cutting edge formed on an end face of the drill.

3. The cutting tool of claim 1, wherein the wear surface, measured from the groove to the cutting edge, has a width between 0.1 mm and 0.3 mm.

4. The cutting tool of claim 1, wherein the groove has a groove depth that is between 0.05 mm and 0.1 mm.

5. The cutting tool of claim 1, wherein the groove has a groove width that is between 0.05 mm and 0.1 mm.

6. The cutting tool of claim 1, wherein the groove runs in a groove direction and, in cross section, has a curved contour transverse to the groove direction.

7. The cutting tool of claim 1, wherein the groove runs parallel to and at a constant distance from the cutting edge.

8. The cutting tool of claim 1, wherein the groove runs from an inner starting point to an outer end point and, with respect to the cutting edge, the groove is at a distance which expands toward the end point.

9. The cutting tool of claim 1 further comprising:
a base body having a number of chip flutes; and
a core formed between the chip flutes, the core having a core diameter,
wherein the groove runs only along an outside of the core diameter.

10. The cutting tool of claim 1, wherein the cutting tool has a nominal radius, and the groove has a groove length that is at least 30% of the nominal radius.

11. The cutting tool of claim 1, wherein the cutting tool has an outer edge, and the groove is formed up to the outer edge.

12. The cutting tool of claim 1, wherein the cutting tool has an outer edge, and the groove extends only up to an end point that is within the clearance face and at a distance from the outer edge.

13. The cutting tool of claim 1, wherein the clearance face is provided with a coating.

14. A cutting element for a rotary cutting tool, the cutting element comprising:
a cutting edge, a rake face connected to the cutting edge, and a clearance face connected to the cutting edge,
wherein the clearance face has a groove disposed in a region along the cutting edge so that the clearance face is formed as a wear surface that extends between the groove and the cutting edge and is bounded by the groove and the cutting edge.

15. A method for manufacturing a rotary cutting tool having a cutting edge, a rake face connected to the cutting edge, and a clearance face connected to the cutting edge, the method comprising:
forming a groove in the clearance face of the cutting tool at a distance from the cutting edge of the cutting tool so that part of the clearance face is formed as a wear face that extends between the groove and the cutting edge, the wear face being bounded by the groove and the cutting edge.

16. The method of claim 15, wherein the groove is formed by a laser.
